(19) United States
(12) Patent Application Publication
(10) Pub. No.: US 2024/0327306 A1
(43) Pub. Date: Oct. 3, 2024

(54) METHOD OF APPLYING LATEX MODIFIED CONCRETE IN HOT CONDITIONS

(71) Applicant: 3SC, INC., Moville, IA (US)

(72) Inventors: Josh P. Martens, Anthon, IA (US); Casey Ryan Jackson, Moville, IA (US); Jeffery Jennings Adkisson, Winterset, IA (US)

(21) Appl. No.: 18/618,549

(22) Filed: Mar. 27, 2024

Related U.S. Application Data
(60) Provisional application No. 63/492,296, filed on Mar. 27, 2023.

(51) Int. Cl. C04B 40/02; C04B 14/06; C04B 24/06; C04B 40/00; C04B 111/60

(52) U.S. Cl. CPC C04B 40/0263; C04B 14/06; C04B 24/06; C04B 40/0025; C04B 2111/60

(57) ABSTRACT

The pouring of latex modified concrete can be done in warm or even hot weather conditions. The latex modifier is treated and kept in a hot condition to let the modified concrete go into final setting, and also kept hot to allow the concrete to cure. Hot water is added to the concrete, while keeping it hydrated. The poured latex modified concrete can be broom finished to provide suitable surface finish. A false atmosphere can be created at the point of placement of the latex modified concrete, as well as at the point of production. This false atmosphere will interact with a controlled temperature modified product to cure.

### CROSS-REFERENCE TO RELATED APPLICATIONS

This application claims the benefit under 35 U.S.C. § 119 to U.S. Provisional Application Ser. No. 63/492,296, filed Mar. 27, 2023, entitled METHOD OF APPLYING LATEX MODIFIED CONCRETE IN HOT CONDITIONS, which is hereby incorporated in its entirety by reference herein.

### TECHNICAL FIELD

The present disclosure relates generally to the application of latex modified concrete. More particularly, but not exclusively, the disclosure includes methods and processes for the application of latex modified concrete in ambient conditions and regardless of the temperature at the ambient conditions.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Latex modified concrete (LMC) is a blend of latex solids-usually around 15 percent—mixed with the concrete at a microscopic level. These solids and how they act once in contact with an inorganic surface are vital to creating the external waterproof layer.

LMC was designed in the 1960s as structural overlay product to repair structural failures on aging bridges. It is a process of adding a polymer base class A modifier to concrete for the purpose of improving freeze thaw resistance, adhesion, impermeability, and chemical resistance. Yet, with all those exemplary increases in performance comes a very temperamental product to produce and place, on top of that a very structured curing process must be maintained.

Industry standards for the production and placement of LMC is to pour at night during summer months, as this product must be produced and then kept within a very narrow temperature band. It is generally too hot during the day and the sun's UV rays greatly affect it as well, causing many adverse reactions. LMC producers use cold water to add to the concrete, even going as far as putting ice in the water tank to get it cold enough.

The surface to be overlaid with LMC has to be pre-hydrated. Many users of LMC use cold water for that as well. The industry standard is to tine it (that is a metal frame with knife like tines that cut grooves in the LMC, the same grooves you find in the highway). The tine is used because as LMC begins to set up, the surface skins just like when you leave the lid off a can of house paint. It is not until it hits this skinned state that you have the opportunity to tine the surface so that it possess a skid/slip free surface.

To date, the tine rake was the only way to do this as this skin tends to come off the top of the finished concrete, destroying the surface of the newly installed LMC. The tine rake has little blade like tines that effectively cut little groves in the surface. Then, it has to be covered with cold, wet burlap and misted with cold water for approximately 24-hours. In short, the entire process is based on trying to keep the LMC from getting too hot!

Thus, there exists a need in the art for processes and other methods that allow for more flexibility, including less dependence on temperature, to apply latex modified concrete.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of any of the aspects of any of the embodiments of the present disclosure to allow for the pouring or application of latex modified concrete in any temperature.

It is still yet a further object, feature, and/or advantage of any of the aspects of any of the embodiments of the present disclosure to allow for broom finishing, as opposed to tine finishing, applied latex modified concrete.

The processes and resulting product disclosed herein can be used in a wide variety of applications. For example, the latex modified concrete as produced using the production methods and processed disclosed are ideal for packing plants, storage facilities, freezers, warehouses, and other enclosed buildings.

It is preferred that the resulting concrete from the processes and/or methods disclosed herein be safe, cost effective, and durable. For example, has excellent bonding adhesion and durability, and higher tensile strength, compressive and flexural strengths all providing better freeze thaw performance and life cycle.

Methods can be practiced which facilitate use, manufacture, assembly, maintenance, and repair of latex modified concrete which accomplish some or all of the previously stated objectives.

According to at least some aspects of the disclosure, method of application of a latex modified concrete comprises creating a false pouring atmosphere at a location for the application of the latex modified concrete, the false pouring atmosphere comprising raising the temperature of a subsurface at the location and keeping the location moist; producing a latex modified concrete mixture having a UV sensitivity; pouring the latex modified concrete mixture at the location having the false pouring atmosphere; and maintaining the false pouring atmosphere to allow the latex modified concrete mixture to cure.

According to at least some aspects of some embodiments disclosed, the method further comprises creating a production false production atmosphere to produce the latex modified concrete mixture having a UV sensitivity.

According to at least some aspects of some embodiments disclosed, the false production atmosphere comprises a controlled temperature in an uncontrolled environment.

According to at least some aspects of some embodiments disclosed, the method further comprises adding hot water to the latex modified concrete mixture to create the false production atmosphere.

According to at least some aspects of some embodiments disclosed, the step of maintaining the false pouring atmosphere to allow the latex modified concrete mixture to cure comprises 24-hours.

According to at least some aspects of some embodiments disclosed, the method further comprises, after the 24-hours, dry curing the latex modified concrete mixture at approximately 24-degrees F. above freezing.

According to at least some aspects of some embodiments disclosed, the method further comprises broom finishing the poured latex modified concrete mixture before allowing it to cure.

According to at least some aspects of some embodiments disclosed, the false pouring atmosphere comprises adding approximately 140 to 180-degree liquid to the location.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a schematic view showing an example of the preparation of a pouring surface to receive latex modified concrete.

FIG. 2 is a schematic view depicting the addition of the latex modified concrete to the pouring surface.

FIG. 3 is a schematic view depicting the curing of the latex modified concrete.

FIG. 4 is an example of a facility showing latex modified concrete being delivered into an interior of the facility.

FIG. 5 is another view of a facility showing the application of latex modified concrete.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used herein have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The use of the terms “false”, “faux”, or “modified” with respect to an atmosphere, environment, and/or location shall be understood to mean that the atmosphere, environment, and/or location has been manipulated in some manner such that it is different that under ambient conditions. Such a modification is a manmade modification and not naturally occurring.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

Latex modified concrete (LMC) was designed in the 1960s as structural overlay product to repair structural failures on aging bridges. It is a process of adding a polymer base class A modifier to concrete for the purpose of improving freeze thaw resistance, adhesion, impermeability, and chemical resistance. Yet, with all those exemplary increases in performance comes a very temperamental product to produce and place, on top of that a very structured curing process must be maintained.

General known standards for the production and placement of LMC is to pour at night during summer months, as the product must be produced and then kept within a very narrow temperature band. Too hot during the day and the sun's UV rays greatly affect it as well, causing many adverse reactions. LMC producers use cold water to add to the concrete, even going as far as putting ice in the water tank to get it cold enough. The surface to be overlaid has to be pre-hydrated, using cold water for that as well. The industry standard is to tine it (that is a metal frame with knife like tines, which cut grooves in the LMC, the same grooves you find in the highway). The tine is used because as LMC begins to set up the surface skins just like when you leave the lid off a can of house paint. It is not until it hits this skinned state that you have the opportunity to tine the surface so that it possess a skid/slip free suffice. To date the tine rake was the only way to do this as this skin wants to come right off the top of the finished concrete destroying the surface of the new LMC just installed, the tine rake has little blade like tines that effectively cut little groves in the surface. Then it has to be covered with cold wet burlap and then misted with cold water for 24-hours. In short, the entire process is based on trying to keep the LMC from getting too hot!

While it has been previously understood that the standards for LMC is to pour at night during summer months and within narrow temperature bands, processes of the present disclosure overcomes many of the issues and/or deficiencies related to the temperature dependence, and allows the pouring of the LMC to be done at a wider range of temperatures and even inside buildings where it may be more difficult to control the ambient temperature.

For example, the processes will allow for pouring at any time and regardless of the temperature. This is done by the use of aspects of the processes disclosed. This is extremely beneficial, as many contractors have no choice but to pour concrete, including LMC, during daylight hours in the summer when the temperatures are generally higher.

Further, extremely tight time windows to apply new concrete may be the only time available in which to pour and set concrete, in which waiting for it to be nighttime (or a time of cooler temperatures) will not work. For example, major-roads which are necessary for use in a city may only have an available 24-hour window in which to tear up concrete, lay and cure LMC, and allow vehicles to travel thereon following the 24-hour mark.

A further example includes in a food grade facility, meat plant, or a packing house such as those that process poultry, swine, or the like, areas in which livestock carcasses are handled and/or stored (in some instances referred to as blast chills) will only have a 48-hour window in which the facility is shut down and new concrete needs to be laid. In these circumstances in which the livestock carcasses are temporarily frozen elsewhere, it is necessary to tear out the old concrete, sanitize the point of placement or area in which concrete will be laid, and to warm it up to temperatures in which the concrete will set before the facility is turned back on and running operations in two days. If the concrete has not reached a high enough temperature to settle or cure, then the concrete will not have solidified which can result in an end product that will never get the desired hardness-concrete that stays soft. This can get messy for a food production facility. Further, this result can lead to an easily damaged floor causing deformities in the floor and later cracks, or simply not bind to the surrounding concrete outside the point of placement. None of these circumstances allow for a proper food-preparation environment, and deformities in the floor including cracks or too deep of grooves are the perfect places for the salts, grimes, fatty-acids, and several other caustic agents that are present in these environments to harbor and grow, and allow bacteria to build in areas that are hard to clean which is one of the last things a food facility wants to worry about.

The introduction of LMC into packing houses has heretofore not been done and packing houses have required (for good maintenance of large facilities) in the past the replacement of their concrete every 4-6 months. Given the incredibly durable and strong characteristics of LMC instead of regular concrete, this allows packing houses to keep the LMC for years without needing replacement.

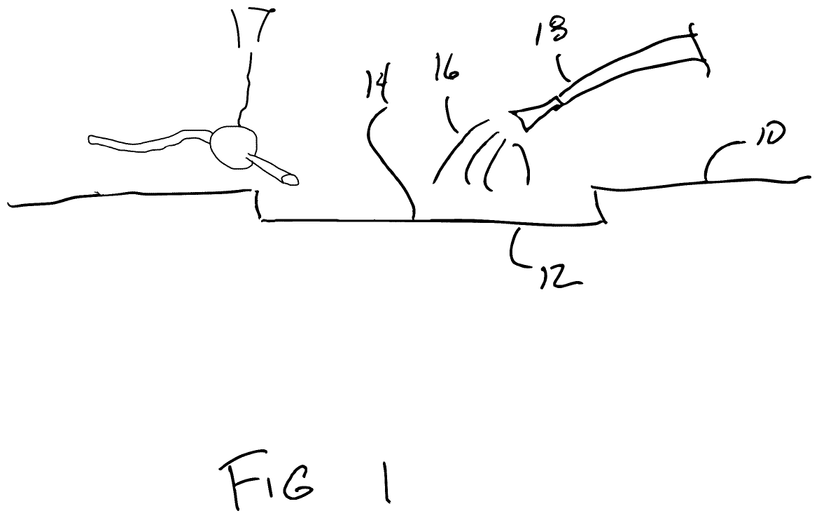

Not only does the present disclosure allow for LMC concrete pouring during the day and not just at night, but it also allows for these variations in different temperature environments to be dealt with. In order to account for the variance in temperatures during pouring, such as during warmer days, aspects of embodiments of the present disclosure include the creation of a false pouring atmosphere 14 at a point of placement 12 for pouring the LMC as shown in FIG. 1.

FIG. 1 includes a location 10, a point of placement 12, a false pouring atmosphere 14, water 16, a hose 18, and a pump 17.

The location 10 may be a floor in a facility or it may be a road or other areas of concrete pouring. Once the point of placement 12 has been created either by digging a pit for it or tearing prior concrete out (this can include using degreasers or doing acid work to sterilize point of placement 12), point of placement 12 can have its temperature manipulated and thus create a false pouring atmosphere 14 by pouring water 16 onto the point of placement 12 with a hose 18 or other water conveyance and getting it to the requisite temperature. Point of placement 12 should be above 39-degrees Fahrenheit, otherwise the concrete will not function and will not settle or cure. Ideally, point of placement 12 will reach a temperature between 70 and 90 degrees Fahrenheit, although is entirely workable in near-ranges such as 60 to 100 degrees Fahrenheit. For purposes of the present disclosure, 70 to 90 degrees is not meant to be limiting, it is to be understood that LMC products function optimally in this range. If false pouring atmosphere 14 is filled with water 16 that was hot coming out of hose 18 (140-180 degree Fahrenheit) but has cooled off to below 39 degrees, pump 17 can then be used to remove water 16 and new water 16 can continue to be poured from hose 18 to continue to raise the temperature of false pouring atmosphere 14. The temperature of false pouring atmosphere 14 may be so cold as to lower 180 degree water 16 coming out of hose 18 because water 16 is being used to warm up a blast chill or an area outside during near-freezing temperatures in which the ground and/or earth has remained at or near below-freezing temperatures for an extended period of time and needs continual heating to create false pouring atmosphere 14.

It can be understood by those of ordinary skill in the art that other ways of heating and creating false pouring atmosphere 14 are possible. Torpedo heaters, concrete blankets, and geothermal heaters, among others can be used. However, the preferred embodiment is to use water 16 because concrete requires moist conditions for optimal settling and binding. Further, it can be understood by those of ordinary skill in the art that location 10 may not be a freezer or cold-outside conditions. Rather, location 10 may be extremely hot and in these circumstances, it will be necessary to cool false pouring atmosphere 14 by introducing cold water 16 to bring false pouring atmosphere to an ideal range of 70 to 90 degrees Fahrenheit.

Further, point of placement 12 may be a section of a floor 10 or the entire floor itself. The size and/or configuration of the area to be poured is not to be limiting on the disclosure.

As noted, one aspect of the process is that point of placement 12 is modified prior to pouring. The area will be under ambient conditions normally, which include, but is not limited to, ambient temperature, humidity, pressure, etc. However, this may be less than ideal for the pouring of the LMC. Therefore, a first step is to modify the area to create a false pouring atmosphere 14 at point of placement 12 which can include cleaning point of placement 12 by removing all fats, greases, caustic agents, and raising the temperature to above 39 degrees. One example of creating such a false pouring atmosphere further involves adding hot water 16 at or near 180-degrees F. to the area 12 to be poured. This may be added in any manner, such as via a hose 18, such as shown in FIG. 1. According to at least some embodiments, the area to be poured (i.e., the subsurface 12) is warmed with water up to about 140 to 180-degrees F.

At or near the same time, the LMC is prepared. This may also be done at a location where a false production atmosphere is used. Hot water is added to the concrete, such as at approximately 180-degrees F. This may be done outside a facility which is having concrete laid therein, or it may be directly next to location 10 and point of placement 12.

As understood by those of ordinary skill in the art, the main ingredients of concrete include water, a cementitious material, a fine aggregate, and a coarse aggregate. Cementitious materials often come from a lime-based material, although not always. Further included in LMC 20 is latex which essentially acts like a less-viscous form of Elmer's glue, said latex replacing a portion of the water that would have been in the concrete thus creating a stickier material that gains additional strength and can withstand pressures within 24-hours of being poured of 6,000 psi.

In various examples of concrete types that may be used, Type I concrete, Type III concrete (Portland Concrete is a viable option), Rapid Set® Latex-Modified Concrete (RSTMC), or FasTrac from Western Material are preferred concrete types to be used as the LMC. It is to be understood that other concrete types can be used without deviating from the scope of this disclosure, such as for example other concrete types like Type I/II or Type V are possible, or other products such as CTS cements. However, Type I/II does not bring a tremendous amount of value over just using I or III, and type V would be used in contexts in which sea-water will be present such as in the context of creating a dam. Choosing concrete type will depend on various factors such as cost, type of finish desired, and time-frame in which the concrete needs to be laid and cured. If it is necessary to cure within a 1-day or 24 hour window, then RSTMC is preferred as it can cure within that required timeframe by utilizing the processes and methods described herein. It utilizes a liquid latex of styrene butiene. If a 2-day or 48-hour window is the required timeframe for curing, then Type III LMC is preferred and is capable of curing within that timeframe by utilizing the processes and methods described herein. If a 4-day cure is the timeframe window, then Type I is preferred and will produce a quality concrete that can be cured within 4 days by utilizing the processes and methods described herein.

Further factors that can encourage different choice of LMC include that Type I is typically less expensive, however, more money per yard is going to go into putting latex into Type I than if Type III or RSLMC are chosen.

Modifiers are added to the concrete before pouring in order to meet the demands of the present job. Various modifiers can include water-reducing admixtures, superplasticizers, set-retarding admixtures, set-accelerating admixtures, citric acid, fiber reinforcements, or air-entraining admixtures. The type of admixtures used will depend on the quality of slump among other factors. For example, if the slump is a 12-inch slump (incredibly watery, i.e., a bowl full of this type of concrete poured onto the floor would go completely flat), then a water-reducing admixture may be necessary to reduce the water content of the LMC mix. This can for example happen if great amounts of water are poured onto the LMC mix in order to heat the LMC mix up or cool the LMC mix down to get into a target temperature zone of 70 to 90 degrees Fahrenheit, and adequate outlets for drain off of the water are not available. Whereas LMC that has a 3-inch slump (if this type of concrete were poured out of a bowl onto the floor and its height was only 3-inches shorter than the height of the bowl, then this is 3-inch slump) may not need the water-reducing admixture.

In another example, if more time is needed to carry the LMC mix between point of production and point of placement 12 then set-retarding admixtures may be added to the LMC mix. In another example, citric acid is a modifier added to the LMC mix to control the set-time in environments that require the presence of only certain allowed chemicals such as in food processing facilities that will not allow the introduction of other chemicals into the flooring that are common forms of set-accelerating or set-retarding admixtures. The LMC is produced to create a controlled temperature in an uncontrolled environment, such as in ambient conditions at point of placement 12. Latex within the LMC is incredibly UV-sensitive and air-sensitive and needs to avoid sun exposure for both efficiency and optimal results and thus creating LMC at point of production in a controlled way maintains the usability of the LMC and maintains the integrity and benefits of LMC.

Further examples may include introducing air-entraining modifiers to gain a desired porosity, or to introduce plasticizers to introduce more plasticity into the end-product LMC.

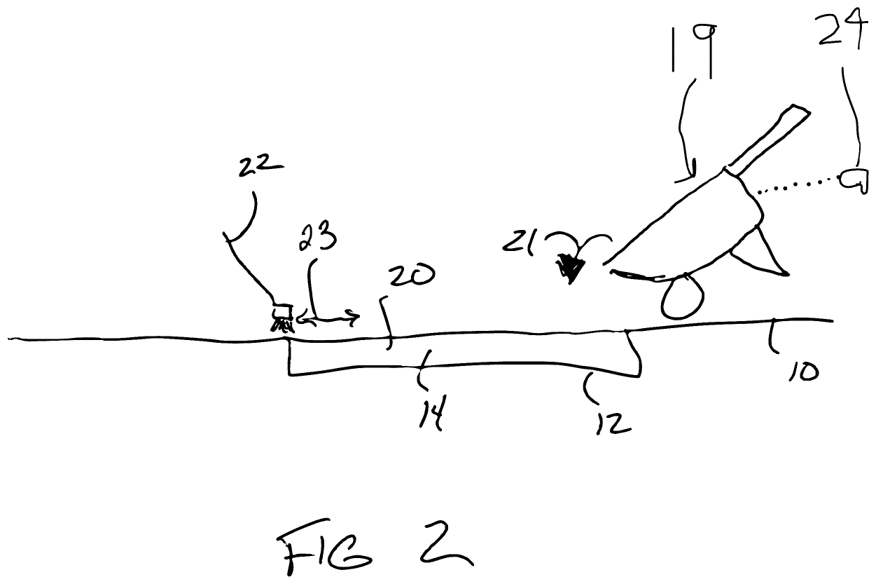

FIG. 2 includes location 10, point of placement 12, false pouring atmosphere 14, means of transport 19, Latex Modified Concrete (LMC) 20, direction 21, broom 22, lateral direction 23, and temperature gun 24.

FIG. 2 shows the next steps, where LMC 20 is poured to and at the false pouring atmosphere 14. The LMC can be carried and poured in any number of ways via means of transport 19, such as including, but not limited to wheelbarrows as shown in FIG. 2, or concrete mixer trucks, pump trucks that utilize a boom arm with pump to get to hard-to-reach arcas, buckets hoisted by cranes, concrete power buggies, conveyor belts with containers, helicopters carrying buckets, or rail transports, lift augers (which can lift LMC and transport it to a later buggy), elevators carrying containers, etc. In any manner, the direction 21 shows the pouring of the LMC at the location of point of placement 12. The process includes maintaining a false pouring atmosphere 14 (e.g., temperature control) during the pouring and placement of the LMC.

Further, this process includes getting LMC 20 to point of placement 12 from a point of production quickly and efficiently. If LMC 20 is not delivered via means of transport 19 quickly enough, then the chemical composition or temperature or otherwise of LMC 20 can be compromised and rendered worthless. A single wheelbarrow or concrete power buggy of means of transport 19 can carry LMC 20 mixture that can cost $850 a load. If the temperature drops too low, or the moisture level drops too significantly and the LMC 20 that is being transported begins to harden in areas within means of transport 19 before LMC 20 is poured onto point of placement 12, then that load may need to be tossed which can slow operations, cause hardening of LMC 20 on equipment, and if ten loads need to be tossed that can be nearly 10-grand worth of concrete that is thrown to the side and wasted. The reason this can happen is because LMC cures incredibly quickly. It is understood by those of ordinary skill in the art that LMC is incredibly volatile. As previously mentioned, if RSLMC is being used for a 24-hour window of laying and curing time, the RSLMC being carried by means of transport 19 will deform and be uneven or clumpy if means of transport 19 is not properly or quickly-enough transported or maintained in a controlled environment and poured into false pouring atmosphere 14.

Indicators that LMC 20 is not being properly transported include exposure to sunlight (latex being UV-sensitive), or incorrect temperature such as dropping below freczing temperatures, or further, windy conditions in which too much air exposure of air molecules being blown onto LMC 20 which can unevenly harden LMC 20. It is therefore recommended that means of transport 19 be monitored during delivery all the way to pouring and can be done with, for example, temperature gun 24. It is understood by those of ordinary skill in the art that temperature gun 24 is not the only way to take the temperature of means of transport 19 as there are many other ways, this is just an easy method to do so. If temperature of LMC 20 within means of transport 19 is 95+ degrees Fahrenheit, the rate of slump-loss will be so drastic that in many instances by the time means of transport 19 reaches point of placement 12, LMC 20 will be a product that is not placeable.

It is also recommended that means of transport 19 be sealed off to maintain isolation from harsh environmental factors such as extreme temperatures or direct sunlight. This can include overlaying it with a tarp, canvas, cloths, burlap, black plastic, or a UV-reflecting plastic if being carried by a wheelbarrow, concrete buggy, container, or bucket. This can further include creating a controlled environment by setting up walls and ceilings, scaffolding, tarps, tents, or the like between point of production of LMC 20 and point of placement 12 for LMC 20 to travel through, and would be entirely appropriate to not cover LMC 20 while in for example a wheel barrow or container on a conveyer belt if means of transport 19 were to travel under said ceilings, tarps, etc. in 80%+ humidity and 80 degree weather, and further, said ceilings and/or tarps would not even be necessary in said weather if transported underneath a canopy of trees. However, this would not be recommended as not having any coverage leaves LMC 20 open to not-as-controlled of an environment and if anything were to enter said uncovered LMC 20 that cause the production materials to be contaminated or cause LMC 20 to change composition, which would be a waste of that $850 being transported. Furthermore, if means of transport 19 were a concrete mixer truck or pump truck, then point of production would be right next to point of placement and transport would be within reach of the concrete mixer truck or pump truck which is creating the mixture of LMC 20.

As understood by those of ordinary skill in the art, about a 10-inch slump is desired, and this can vary depending on what end-product is desired such as having an 8-inch to an 11-inch slump, however 10-inch slump is considered optimal. If for whatever reason control is lost within the controlled environment in which LMC 20 is transported and poured (temperature goes out of range either too hot or too cold, sun exposure, etc.) then roughly only 25 minutes of workability are left on LMC 20. If point of placement 12 is 2-minutes away

It should noted that one of the typical goals of laying LMC instead of just concrete is not only to lay concrete fast but is to create an incredibly strong structure. In this regard, if the goal is not only to lay down an overlay but also to improve the structure of the area being fixed (point of placement 12), then it is crucial that point of placement 12 be moisture-rich for 24-hours prior to the placement of LMC for the adhesion of LMC to the surrounding concretes, thus creating a structural overlay and not just an overlay. As understood by those of ordinary skill in the art, this 24-hours of moisture rich point of placement 12 is not possible in windows in which only 24-hours are available to tear out old concrete and cure LMC 20. It is therefore recommended in these situations that point of placement 12 be soaked as thoroughly as possible (with pooling water being pumped out prior to laying LMC 20) with water 16 prior to pouring LMC 20 rather than using alternate methods of manipulating false pouring atmosphere 14 to reach the target window of 70 to 90 degrees Fahrenheit in order to improve adhesion of LMC 20 to surrounding concrete.

It should further be noted that while traditional LMC placement includes tine finishing, this may or may not be a part of the processes disclosed herein. In indoor pouring, such as warehouses, coolers, packing plants, factories, and the like, tine finishing may be unwanted or otherwise unacceptable. In such a location, LMC 20 may instead need to be broom finished (see, e.g., the broom 22 moving in the direction of the arrow 23 in FIG. 2).

Broom finished concrete is concrete finished by dragging a horsehair broom, or something similar, over its wet surface. Brushing the concrete makes for a textured surface with small, but noticeable grooves which improves the grip of LMC 20 to users or vehicles that may travel thereon. It can be undesirable (though not always) to have a slick concrete-finish, thus utilizing broom 22 can provide benefits to said users or vehicles. Further, creating grooves with broom 22 can improve life of the laid concrete which allow for subtle expanding and contracting due to temperature and/or moisture variations without causing any unwanted cracks along a surface of LMC 20. The broom finishing can be accomplished by sweeping or brushing in such a manner that the skinned surface of the LMC is not ripped off or otherwise removed, which aids in maintaining the structural integrity of the LMC. Thus, the LMC 20 in FIG. 2 has been poured and broom finished.

In order to accomplish said broom finishing with broom 22, it is necessary to broom the surface of the concrete once it starts to firm up, and before it becomes too hard. The way to tell that the time is right is after skin has begun forming on the surface of LMC 20 and before the laid concrete changes color. It may be too late to broom finish the surface if color of LMC 20 has begun to change, and it is too early to broom finish the surface if skin has not formed enough and LMC 20 is just wet and sloppy. Doing it too early will result in a sloppy and rougher finish than is desirable and doing it too late (after color has changed) will result in the surface not being malleable enough to create the surface finish. Another indicator that the skin on surface of LMC 20 has hardened enough is that concrete-when-laid tends to have a glossy look to it. Once that glossy look begins to disappear it is almost as though the surface of LMC 20 will flash (onset before color change) and this is optimal time to begin broom finishing.

Broom finishing will be accomplished by pushing broom 22 in lateral direction 23. In most contexts walking on laid LMC 20 will not be possible, so it is therefore desirable to use a long pole on which an end of broom 22 is attached to. In another example, a regular sized broom 22 is used and alternate rows or sections of laying LMC 20 so as to have a reachable surface in which broom 22 can be applied.

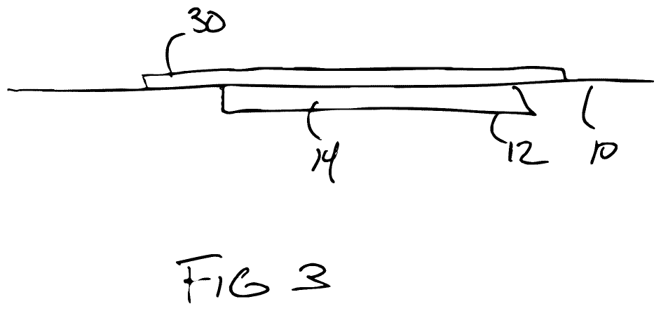

Next, moving to FIG. 3, FIG. 3 includes location 10, point of placement 12, false pouring atmosphere 14, and wet burlap 30, in which an example depiction of curing of the LMC 20 is shown. To aid in curing the LMC in a proper manner, a false placement atmosphere is created and maintained during curing. According to at least some embodiments, the false placement atmosphere comprises coverage of the poured LMC 20 with wet burlap 30 for a time, such as 24-hours. The burlap 30 may be wetted with cooler water to allow the LMC 20 to cure, such as by misting the burlap with cold water over the 24-hour curing period. Alternatively, wet burlap 30 may be covered with plastic to retain moisture within burlap 30 thus aiding in maintaining LMC 20 in a moist-enough environment to allow for proper setting of the chemical reactions hardening the material. Thus, burlap 30 assists in maintaining false pouring atmosphere 14.

Further, if temperature is an issue over the 24-hour period of overlaying burlap 30, tying runs of hose-coils through a concrete blanket and recirculating controlled-temperature water through the hose-coils effectively creates a massive, heated blanket so as to allow LMC 20 to cure within temperature range of 70 to 90 degrees.

Within the first 5 hours of laying burlap 30 it is recommended that checks every half hour are maintained such that a temperature of at least 65 degrees is maintained and burlap 30 is still thoroughly moist. If a section of laid LMC 20 is only at 54 degrees for example, that section will not cure properly in accordance with the surrounding LMC 20 which results in a weak area that will retain viscous/fluid-like properties and if for example this 54-degree section is on a section of road, that section of road may overtime shift ever so slightly with vehicles that apply the brakes on that portion thus creating a valley-and-hill formation rather than maintaining the originally desired shape. If this error is not caught within a processing house it can result in penalties in pay from the client for lack-of-quality finish. From hours 5 through 10, it is recommended that checking the moisture and temperature is performed every other hour. Using a Rebound Hammer or a Swiss Hammer during this checking process further allows for checking of compressive strength during the curing process, which is a necessary tool if RSLMC is being used because RSLMC cures so quickly that samples cannot be taken to a lab quick enough to take compressive samples before it has hardened too far beyond the ability to alter the curing process.

After the 24-hour curing period, the wet burlap 30 can be removed, and the LMC can be dry-cured. The dry-curing time can vary, but it is recommended that it occur at a temperature above freezing and that it be at least 24-hours. It is entirely possible to skip this 24-hour drying period if using RSLMC and working within a 24-hour window between tearing out concrete and curing and the laid-and-cured RSLMC will be entirely capable to bear the desired load-limits and have the desired strength, however if the drying period is skipped it will result in the concrete having a lower resistance to caustics, or rather, a high permeability to caustic agents (motor oil, etc.) rather than keeping those agents out of the concrete.

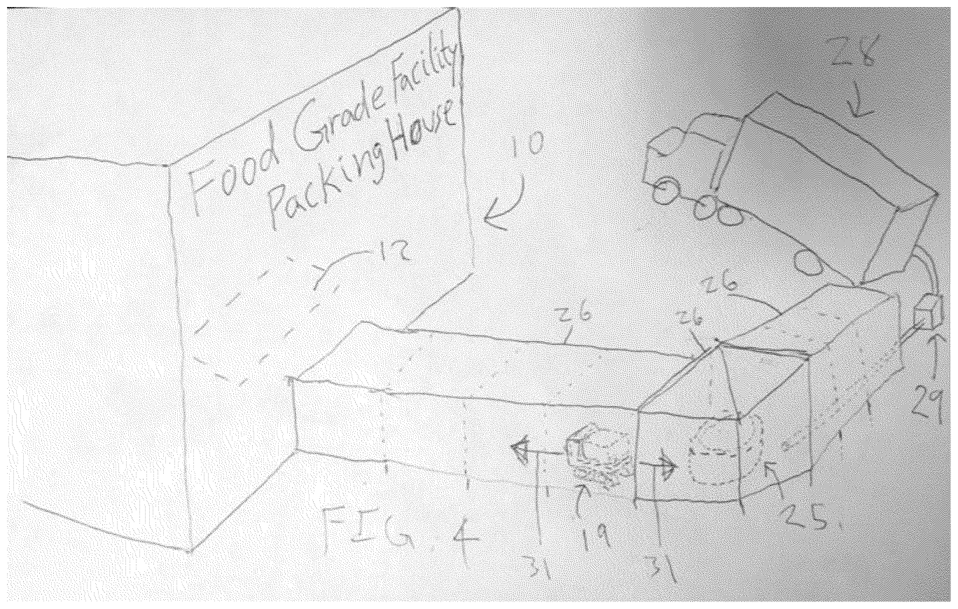

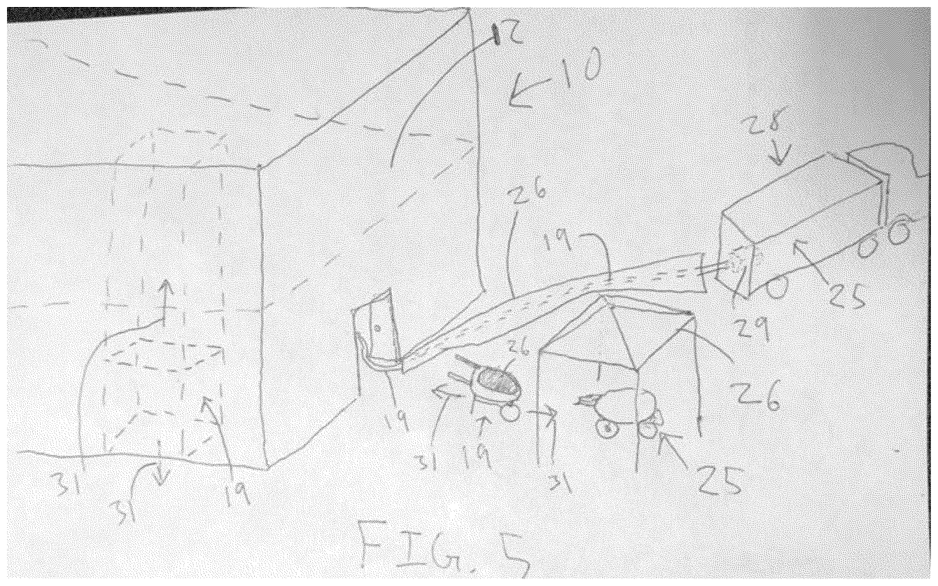

FIGS. 4-5 show exemplary uses of the methods described herein and include location 10, point of placement 12, means of transport 19, point of production 25, covering 26, food-grade trailer 28, pumping/filtering facility 29, and direction arrows 31.

Location 10 shown in FIGS. 4-5 can be a food production facility or processing house. Seen within location 10 is point of placement 12 wherein LMC 20 will be poured. Means of transport 19 can include wheelbarrows, concrete mixer trucks, pump trucks that utilize a boom arm with pump to get to hard-to-reach areas, buckets hoisted by cranes, concrete power buggies, conveyor belts with containers, helicopters carrying buckets, or rail transports, first and/or secondary lift augers (which can lift LMC and transport it to a later buggy), elevators carrying containers, etc., and shown in FIG. 4 is a motor buggy as means of transport 19, whereas in FIG. 5 multiple means of transport 19 are shown including a wheelbarrow, a pump line coming from a pump truck, and an elevator to get LMC 20 onto a second floor of location 10. These examples are in no way limiting to just the examples shown, as for example point of placement 12 could be on a sixth floor in which multiple variations and combinations of the disclosed means of transport 19 are used. Means of transport 19 receives LMC 20 from point of production 25 to transport and pour product into point of placement 12. Further, covering 26 is shown in FIGS. 4 and 5. Covering 26 can be tents, tarps, plastics, reflecting blankets, burlap, canvas etc. In FIG. 4, mainly tent and set-up plastics or tarps are used to create a controlled environment for means of transport 19. Further, point of production 25 is covered by covering 26 for protection from UV-rays, wind, and temperature to create a false production atmosphere thus maintaining optimal temperature and moisture of LMC 20. In harsh environments, water of 140-180 degrees may be poured onto LMC 20 mixture so as to maintain a temperature of 70 to 90 degrees for the LMC mixture. In FIG. 5, a tent is shown for covering 26 as well as a plastic covering on a wheelbarrow and further a plastic covering for a pump-line coming from a pump truck, said pump line and wheelbarrow each being a means of transport 19. Point of production 25 can also be within food-grade trailer 28, which can also be a pump truck, and in both instances temperature and moisture can be optimally maintained. In FIG. 5 pumping/filtering facility 29 is disposed within food-grade trailer 29, whereas in FIG. 4, pumping/filtering facility 29 is disposed outside of food-grade trailer 28. Food-grade trailer 28 is capable of storing latex, other modifiers or admixtures (air entrenchment, citric acid, water-reducer, etc.), or water. Food-grade trailer 28 can further hold sands, rocks, etc., however storing of liquids within food-grade trailer 28 is more desirable for the pumping capability. Food-grade trailer 28 is capable of maintaining temperatures of 4 to 108 degrees.

Ambient temperature within tents must be at least 40 to 50 degrees Fahrenheit, whereas point of placement 12 in which LMC 20 is poured is optimally 70 to 90 degrees. It is recommended that sand and rock bunkers are stored indoors or in both a controlled temperature environment and controlled moisture environment so that addition of these materials to LMC 20 (if needed) will not alter the temperature of LMC 20 mix so as to throw it out of a window of operability. Concrete blankets and geothermal heaters are great tools to control temperature of sand, rock, and other aggregate (non-liquids, in which liquids may preferably be stored in food-grade trailer). Forced-air heat is not ideal because then it dries the sand out and this can throw LMC 20 mix outside the desirable range of slump and thus limit workability time from mix-to-pour. Because of this, it is recommended that cement be stored in super-sacks (roughly 2000-lbs bulker bags which can easily be forklifted inside) prior to mixing for easier control of temperature rather than keeping all cement in a large-outdoor silo. One recommendation is to store aggregate, sand, and/or rock in a pile indoors in a temperature controlled environment covered with a moisture-containing tarp for two-weeks prior to mixing so as to create reliable uniformity across the entirety of the material. This is desirable because a large percentage of LMC 20 mix is rock and sand and uniformity in the temperature and moisture of rock and sand can greatly influence the overall temperature and moisture of LMC 20 mix. Further, a temperature-controlled environment can include food-grade trailer 28, any of covering 26, or means of transport 19, or an indoor area. For example, temperature-controlled environment can be under a tent from covering 26 surrounded by tarp. This can further be enhanced by introducing heated or cooled water into the temperature-controlled area and onto LMC 20. In another non-limiting example, temperature-controlled environment can be a sealed-off motor buggy, or a cement mixing truck. In yet another non-limiting example, temperature-controlled environment can include placing reflecting blankets from covering 26 on top of LMC 20.

Further, means of transport 19 can travel in multiple directions as seen by direction arrows 31. Means of transport 19 can travel both to point of production 25, from point of production 25, to point of placement 12 and from point of placement 12.

Therefore, as noted, the process(es) described herein include a way to use a product (i.e., LMC) that to date has been required to be kept cool and in the dark so the modifier did not set up before the concrete could be made with it and could be finished before it goes into final set, then kept cool so that it did not crack all apart while curing. Thus, the describes processes and methods herein disclose how to control the environment of LMC so as to be able to use it in otherwise harsh conditions such as within blast chills within large facilities or on outdoor surfaces that are otherwise harsh environments for LMC due to factors not limited to extreme temperatures, precipitation, sunlight, or wind, through the creation of pocket environments within a harsh environment and quick/efficient use of and diligent monitoring of LMC. In areas such as blast chills which are never conducive to laying LMC, these processes and methods described herein provide a way to allow the laying of LMC on said areas.

In short, and without limitation, an example process includes the following:
1. create a false atmosphere at point of placement;
2. create a false atmosphere at point of production;
3. produce a controlled temperature/extremely UV-sensitive modified concrete product in an uncontrolled environment while maintaining usability;
4. place and finish in a precise and timely fashion without disturbing placement atmosphere or chemical reactivity of modified concrete;
5. maintain false placement atmosphere for approximately 24-hours (hot and Moist); and
6. dry cure 24-hours at a temperature above freezing.

1. A method of application of a latex modified concrete, the method comprising:
creating a false pouring atmosphere at a location for the application of the latex modified concrete, the false pouring atmosphere comprising raising the temperature of a subsurface at the location and keeping the location moist;
producing a latex modified concrete mixture at a point of production;
transporting the latex modified concrete mixture to the point of placement;
pouring the latex modified concrete mixture at the point of placement having the false pouring atmosphere; and
maintaining the false pouring atmosphere to allow the latex modified concrete mixture to cure.

2. The method of claim 1, further comprising creating a false production atmosphere at the point of production to produce the latex modified concrete mixture having a UV sensitivity.

3. The method of claim 2, wherein the false production atmosphere comprises a controlled temperature in an uncontrolled environment comprising adding hot water to the latex modified concrete mixture to create the false production atmosphere.

4. The method of claim 3, further comprising adding 140 to 180 degree Fahrenheit water onto the latex modified concrete mixture while the latex modified concrete mixture is under a covering.

5. The method of claim 1, wherein the step of maintaining the false pouring atmosphere to allow the latex modified concrete mixture to cure comprises 24-hours.

6. The method of claim 5, further comprising, after the 24-hours, dry curing the latex modified concrete mixture for another 24-hours.

7. The method of claim 1, further comprising broom finishing the poured latex modified concrete mixture before allowing it to cure.

8. The method of claim 1, wherein the false pouring atmosphere comprises adding approximately 140 to 180-degree liquid to the point of placement.

9. A method of application of latex modified concrete, the method comprising:
creating a false production atmosphere by maintaining a temperature-controlled environment and within the temperature-controlled environment is disposed any one of the group consisting of: a latex, a water, and a modifier, a rock, or a sand;
mixing any of the latex, the water, the modifier, the rock, or the sand, with a latex modified concrete;
transporting the latex modified concrete through an environment that is outside a range of 70 and 90 degrees Fahrenheit to a point of placement while maintaining temperature of the latex modified concrete between 70 and 90 degrees Fahrenheit;
soaking a point of placement in water to either raise or lower a temperature of the point of placement to between 70 and 90 degrees Fahrenheit; and
pouring the latex modified concrete onto the point of placement.

10. The method of claim 9, wherein the point of placement is within a food processing facility.

11. The method of claim 10, wherein the modifier comprises citric acid, and the citric acid is mixed into the latex modified concrete.

12. The method of claim 9, further comprising covering the poured latex modified concrete with a burlap that has been soaked.

13. The method of claim 12, further comprising covering the burlap with a plastic.

14. The method of claim 12, further comprising checking a temperature of the latex modified concrete at least once every half hour for the first five hours after covering the poured latex modified concrete with the burlap.

15. The method of claim 9, further comprising transporting the latex modified concrete via a wheelbarrow.

16. The method of claim 15, further comprising covering the wheelbarrow with plastic.

17. The method of claim 16, further comprising taking a temperature of the wheelbarrow while the wheelbarrow is transporting the latex modified concrete.

18. A method of transporting latex modified concrete, the method comprising:
raising a temperature of an area intentionally refrigerated within a past 24-hours via pouring hot water onto the area;
allowing said area to raise to a range between 70 to 90 degrees;
removing said hot water via a pump;
transporting the latex modified concrete via a means of transport to the area; and
pouring the latex modified concrete onto the area.

19. The method of claim 18, wherein the means of transport includes a motor buggy, wherein the motor buggy has a covering over the latex modified concrete and the motor buggy travels from a point of production to the area.

20. The method of claim 18, further comprising broom finishing the latex modified concrete after the latex modified concrete has had 24-hours to cure.
